(19) United States
(12) Patent Application Publication
(10) Pub. No.: US 2024/0312303 A1
(43) Pub. Date: Sep. 19, 2024

(54) TECHNIQUES FOR TRACKING TRENDING ACTIVITY WITHIN A SPORTSBOOK PLATFORM

(71) Applicant: DK CROWN HOLDINGS INC., Boston, MA (US)

(72) Inventors: Joshua Nadler, Walpole, MA (US); Matt Robinson, Everett, MA (US); Jacqueline Quill, Lancaster, MA (US)

(21) Appl. No.: 18/607,411

(22) Filed: Mar. 15, 2024

Related U.S. Application Data
(60) Provisional application No. 63/452,647, filed on Mar. 16, 2023.

(51) Int. Cl. G07F 17/32

(52) U.S. Cl. CPC G07F 17/323; G07F 17/3288

(57) ABSTRACT

Techniques for identifying trending activity on a software-based platform (e.g., an online sportsbook platform) can include a computing system that receives data corresponding to an event occurring at a point in time within the platform. The computing system can identify characteristics associated with the data corresponding to the event and update state data associated with each identified characteristic in a data store maintaining time-series data that represents events that have occurred within the software-based platform. The data can be indexed as a time-series representation based on the point in time associated with the event and on the identified characteristics. The computing system can provide data consumer devices access to the time-series data via application programming interface functions.

### CROSS-REFERENCE TO RELATED APPLICATIONS

This application claims the benefit of U.S. Provisional Application No. 63/452,647, filed on Mar. 16, 2023. The entire contents of this application are incorporated by reference herein.

### BACKGROUND

Online sportsbook platforms allow individuals to wager on sports competitions over the Internet. The individual can wager on various outcomes in a given sport. Identifying trends in betting activity within an online sportsbook platform is a known issue in the technical field. Individual bettors, third-party services that promote the platform activity (e.g., social media networks, sports leagues, sports and entertainment news media, etc.), and other parties may benefit from knowing trends relating to platform engagement, such as bet placements. However, current approaches to obtaining trends are cumbersome. For example, one approach generally involves a platform application executing a query on bet placement transactions and publishing relevant trending data to the platform, which may later be consumed by the individuals or third-party services. This approach is generally unilateral in which consumers pull trending activity only when made available by the platform.

### SUMMARY

Embodiments presented herein disclose techniques for tracking trending activity based on a stream aggregation of event objects representing bet placements within an online sportsbook platform. At least one of the embodiments of the present disclosure provides a method. The method generally includes receiving, by a computing system, data corresponding to an event occurring at a point in time within a software-based platform. A plurality of characteristics associated with the data corresponding to the event is identified. State data associated with each identified characteristic is updated in a data store that maintains time-series data. The time-series data represents a plurality of events that have occurred within the software-based platform. The data corresponding to the event is indexed in the data store as a time-series representation based on the point in time associated with the event and on the identified plurality of characteristics. The method also generally includes providing, to one or more data consumer devices, access to the time-series data via a plurality of application programming interface (API) functions.

The present disclosure also includes a system having one or more processors and a memory storing a plurality of instructions, which, when executed on the processor, cause the system to receive data corresponding to an event occurring at a point in time within a software-based platform. A plurality of characteristics associated with the data corresponding to the event is identified. State data associated with each identified characteristic is updated in a data store that maintains time-series data. The time-series data represents a plurality of events that have occurred within the software-based platform. The data corresponding to the event is indexed in the data store as a time-series representation based on the point in time associated with the event and on the identified plurality of characteristics. Access to the time-series data is provided to one or more data consumer devices via a plurality of application programming interface (API) functions.

The present disclosure also includes a computer-readable storage medium storing a plurality of instructions, which, when executed on the processor, cause a computing system to receive data corresponding to an event occurring at a point in time within a software-based platform. A plurality of characteristics associated with the data corresponding to the event is identified. State data associated with each identified characteristic is updated in a data store that maintains time-series data. The time-series data represents a plurality of events that have occurred within the software-based platform. The data corresponding to the event is indexed in the data store as a time-series representation based on the point in time associated with the event and on the identified plurality of characteristics. Access to the time-series data is provided to one or more data consumer devices via a plurality of application programming interface (API) functions.

### BRIEF DESCRIPTION OF THE DRAWINGS

The foregoing aspects and other features of the disclosure are explained in the following description, taken in connection with the accompanying example drawings relating to one or more embodiments.

FIG. 1 illustrates an example computing environment in which an online sportsbook platform tracks and provides trending activity in bet placement data, according to some embodiments of the present disclosure;

FIG. 2 further illustrates an example server in the online sportsbook platform of FIG. 1, according to some embodiments of the present disclosure;

FIG. 3 illustrates an example environment that may be established by the online sportsbook platform of FIG. 1, according to some embodiments of the present disclosure;

FIG. 4 illustrates an example method flow for building a time-series representation of bet placement data within the online sportsbook platform of FIG. 1, according to some embodiments of the present disclosure;

FIG. 5 illustrates an example method flow for providing trending activity from the time-series representation of bet placement data of FIG. 4, according to some embodiments of the present disclosure; and

FIG. 6 illustrates an example output of trending activity, according to some embodiments of the present disclosure.

### DETAILED DESCRIPTION

Embodiments presented herein disclose techniques for identifying trending activity within an online sportsbook platform. As further described herein, the techniques provide a system and methods for tracking persistent states associated with one or more characteristics of an event object. An event object may relate to a bet placement transaction that a user makes on the platform at a given point in time. Such characteristics may include types of bet (e.g., a moneyline bet, a spread bet, and over/under bet, etc.), whether the bet relates to a single bet or a parlay bet, market type, betting jurisdiction, sport league, teams involved, and so on. The system further indexes such event objects as time-series data. In doing so, the system is able to retrieve trending bets in terms of the persisted states within a given time window for a given event characteristic. For example, through these techniques, the system is able to track trends in moneyline bets and other associated characteristics (e.g., outcomes) for a given team over the last week, over the last two weeks, etc.

In addition, the system may provide an application programming interface (API) allowing access to the collected time-series event data to consumer users such as individuals, marketing channels, and other third-party entities (e.g., social media networks, sports and entertainment sites, etc.). In an embodiment, the API provides functions to, for example, query the system and retrieve aggregate event object data for a given time period. Doing so enables a consumer to identify trends in bets, betting markets, bet outcomes, betting splits, and the like occurring on the online sportsbook platform. For example, a consumer device, such as that of a third-party affiliate, may transmit an API call to query for popular bets for an upcoming major sports event. In turn, the server may filter the collected time series data based on parameters including types of bets, event name, and a time period and return a smaller time window of event objects data that satisfies the query. Thereafter, the consumer device may publish the resulting data on an associated website to promote further engagement, e.g., within the online sportsbook service or the affiliate's own services.

Advantageously, the embodiments of the present disclosure use stream aggregation to represent event object data of an online sportsbook platform as a time-series. Further, representing event characteristics based on persisted states allows for fast access to current and historical trending data and also reduces the amount of writes to a database. Further still, compared to prior approaches of publishing trending data for specific events at certain intervals, the techniques of the present disclosure expose API access to data consumer devices which allows consumers to tailor queries and obtain trending data as event object data is collected in real-time. Such data may then be used to promote certain events, aid in marketing campaign design, promote the online sportsbook platform, etc.

Note, the present disclosure uses an online sportsbook platform as a reference example of a software computing environment in which characteristics of events data are discretized, tracked, and made accessible to data consumer entities. Of course, the embodiments disclosed herein may be adapted to a variety of other software platforms in which identifiable events occur, such as actions in online fantasy sports platforms, financial trading platforms, logged activity for purposes of cybersecurity in enterprise networks, travel agency platforms, and so on.

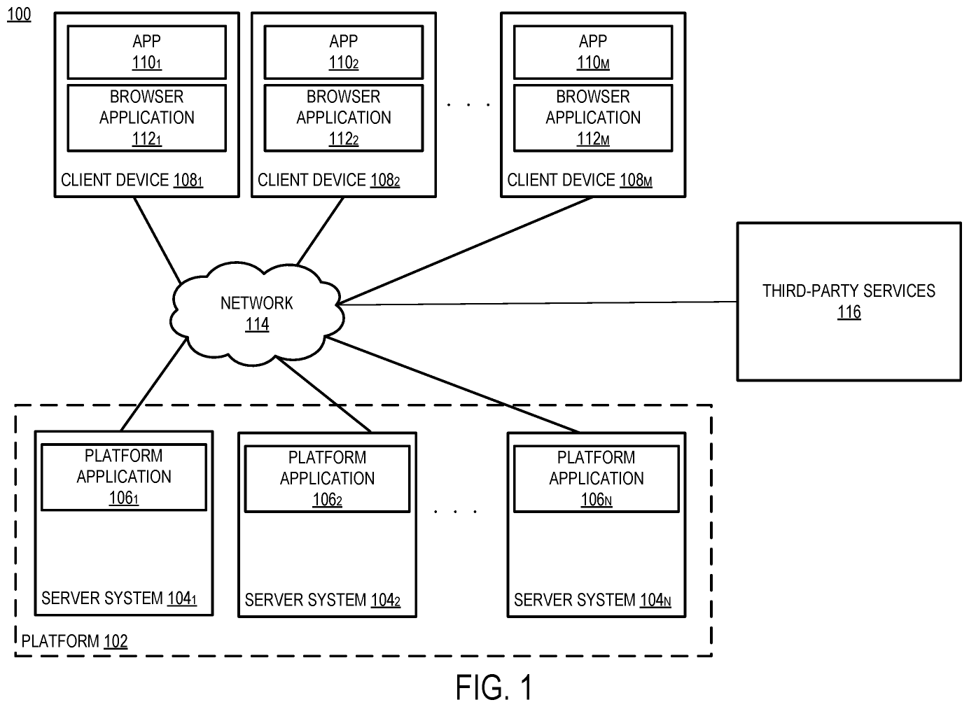

Referring now to FIG. 1, an example computing environment 100 is provided. As shown, the computing environment 100 includes a platform 102 which includes server systems 104_{1-N}. The computing environment 100 further includes client devices 108_{1-M} and third-party services 116. Each of the server systems 104, client devices 108, and third-party services 116 are interconnected via a network 114, such as the Internet.

In an embodiment, the server systems 104 of the platform 102 relate to computing resources used to provide a sports entertainment and gaming platform executing one or more services, such as an online sportsbook service, fantasy sports service, casino service, and the like. The services may execute via one or more platform applications 106_{1-N}. A server system 104 may be embodied as a physical computing system or a virtual computing instance executing in a cloud environment. The server systems 104 may be physically and/or logically grouped to provide the one or more services via the platform applications 106_{1-N}.

Client devices 108_{1-M} may access the platform applications 106_{1-N} through a variety of means, such as through a platform-specific app 110 or through a web interface via a browser application 112. Via the app 110 (or the web interface), a user of the platform may access a sportsbook service provided by the platform applications 106_{1-N} to place bets on various sporting events. For example, the user may place a moneyline or spread bet on an outcome of a football game taking place on a given date. As another example, the user may place a parlay bet on a number of outcomes occurring across multiple sporting events. A client device 108 may be embodied as a physical computing system (e.g., a desktop computer, laptop computer, mobile device such as a smartphone or tablet, etc.) or a virtual computing instance executing on a cloud provider network.

In an embodiment, the third-party services 116 may correspond to endpoint servers of entities that may engage with the platform 102 via one or more application programming interfaces (APIs). An example third-party service 116 may correspond to a social media network service that uses the APIs provided by the platform 102 to perform functions such as retrieving sportsbook data to be shared on the profile of a user of the social media network. Another example third-party service 116 may correspond to a marketing channel that generates content (e.g., newsfeed posts, banner images, etc.) based on data retrievable from the platform 102.

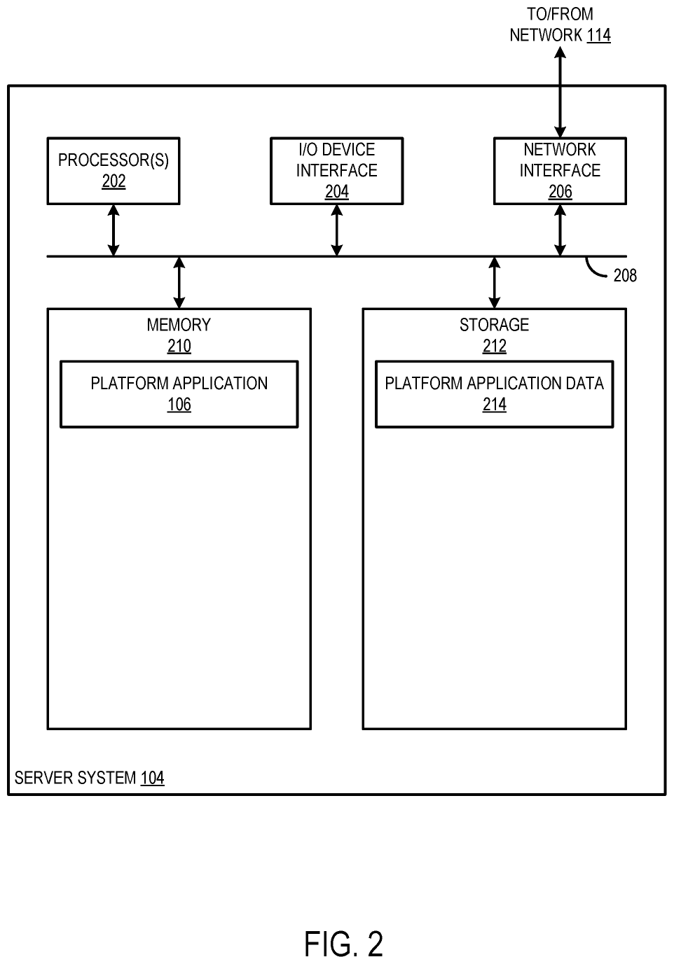

Turning briefly to FIG. 2, a block diagram further illustrating hardware and software components of an example server system 104 is shown. As shown, the server system 104 includes, without limitation, one or more processors 202, an I/O device interface 204, a network interface 206, a memory 210, and a storage 212, each interconnected via a hardware bus 208. Of course, the actual server system 104 will include a variety of additional hardware (or software-based) components not shown. Additionally, in some embodiments, one or more of the illustrative components may be incorporated in, or otherwise form a portion of, another component.

The processor 202 retrieves and executes programming instructions stored in the memory 210 capable of performing the functions described herein. The processor 202 may be embodied as a single or multi-core processor(s), a graphics processor, a microcontroller, or other processor or processing/controlling circuit. In some embodiments, the processor 202 may be embodied as, include, or be coupled to a field programmable gate array (FPGA), an application-specific integrated circuit (ASIC), reconfigurable hardware or hardware circuitry, or other specialized hardware to enable performance of the functions described herein. The hardware bus 208 is used to transmit instructions and data between the processor 202, storage 212, network interface 206, and the memory 210. The memory 210 may be embodied as any type of volatile (e.g., dynamic random access memory, etc.) or non-volatile memory (e.g., byte addressable memory) or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces.

The network interface 206 may be embodied as any hardware, software, or circuitry (e.g., a network interface card) used to connect the server system 104 over the network 114 and providing the network communication component functions described above. For example, the network interface 206 may be embodied as any communication circuit, device, or collection thereof, capable of enabling communications over the network 114 between the server system 104 and other devices. The network interface 206 may be configured to use any one or more communication technology (e.g., wired, wireless, and/or cellular communications) and associated protocols (e.g., Ethernet, Bluetooth®, Wi-Fi®, WiMAX, 5G-based protocols, etc.) to effect such communication. For example, to do so, the network interface 206 may include a network interface controller (NIC, not shown), embodied as one or more add-in-boards, daughtercards, controller chips, chipsets, or other devices that may be used by the server system 104 for network communications with remote devices (e.g., client devices 108, endpoint servers executing third-party services 116). For example, the NIC may be embodied as an expansion card coupled to the I/O device interface 204 over an expansion bus such as PCI Express.

The I/O device interface 204 allows I/O devices to communicate with hardware and software components of the server system 104. For example, the I/O device interface 204 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O device interface 204 may form a portion of a system-on-a-chip (SoC) and be incorporated, along with one or more of the CPU/GPU 202, the memory 210, and other components of the server system 104.

The I/O devices (not shown) may be embodied as any type of I/O device connected with or provided as a component to the server system 104, such as keyboards, mice, and printers. Illustratively, the memory 210 includes the platform application 106, which is configured to, in part, receive event data corresponding to betting activity, identify one or more characteristics associated with the betting activity, update and maintain tracking state data associated with the one or more identified characteristics with the event data, and indexing the event data.

The storage 212 may be embodied as any type of device configured for short-term or long-term storage of data such as, for example, memory devices and circuits, memory cards, hard disk drives (HDDs), solid-state drives (SSDs), or other data storage devices. The storage 212 may include a system partition that stores data and firmware code for the storage 212. The storage 212 may also include an operating system partition that stores data files and executables for an operating system. As shown, the storage 212 includes platform application data 214. The application data 214 may be embodied as any type of data generated or maintained by the platform application 106, such as user account data, event data, trending data, etc.

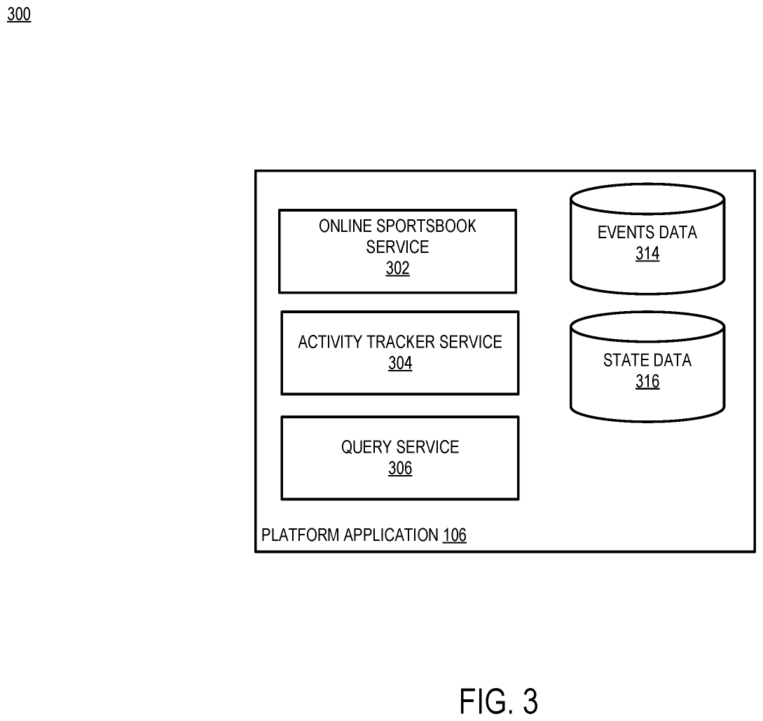

Referring now to FIG. 3, the platform application 104, by operation of the processors 202, may execute an environment 300. As shown, the environment 300 includes an online sportsbook service 302, an activity tracker service 304, query service 306, events data 314, and state data 316.

The online sportsbook service 302 may be embodied as any hardware, software, or circuitry providing functions relating to an online sports betting service. For example, the online sportsbook service 302 may comprise one or more modules for allowing users to place bets on sports events, view placed bets by the user and other users, view betting odds associated with various events, and the like. Each placed bet transaction may be stored as an event object in events data 314. A given event object may include one or more characteristics, such as a name of the event, market type, teams or individuals involved in the event, bet handle (e.g., amounts for bets), wagered outcomes, date and time of the event, geographical region associated with the event, geographical region associated with the placed bet, and so on.

The activity tracker service 304 may be embodied as any hardware, software, or circuitry providing functions for identifying trending activity within the events data 314. For example, the activity tracker service 304 may maintain tracking counts of the aforementioned characteristics associated with an event object representing a bet placement. As the events data 314 receives new event objects, the activity tracker service 304 may increment respective counts. Further, the activity tracker service 304 may maintain state data 316, which may be used to provide a cached local copy of counts by event, e.g., for a given sports league. The activity tracking service 304 may use the state data 316 to perform in-memory aggregation operations such as counting, sorting, and filtering on the cached counts.

The query service 306 may be embodied as any hardware, software, or circuitry for retrieving and transmitting trending activity in response to queries from data consumer devices (e.g., client devices 108 and devices associated with third-party services 116) for trending data based on a given period of time. In some embodiments, the query service 306 may be representative of one or more application programming interface (API) endpoints callable by the data consumer devices.

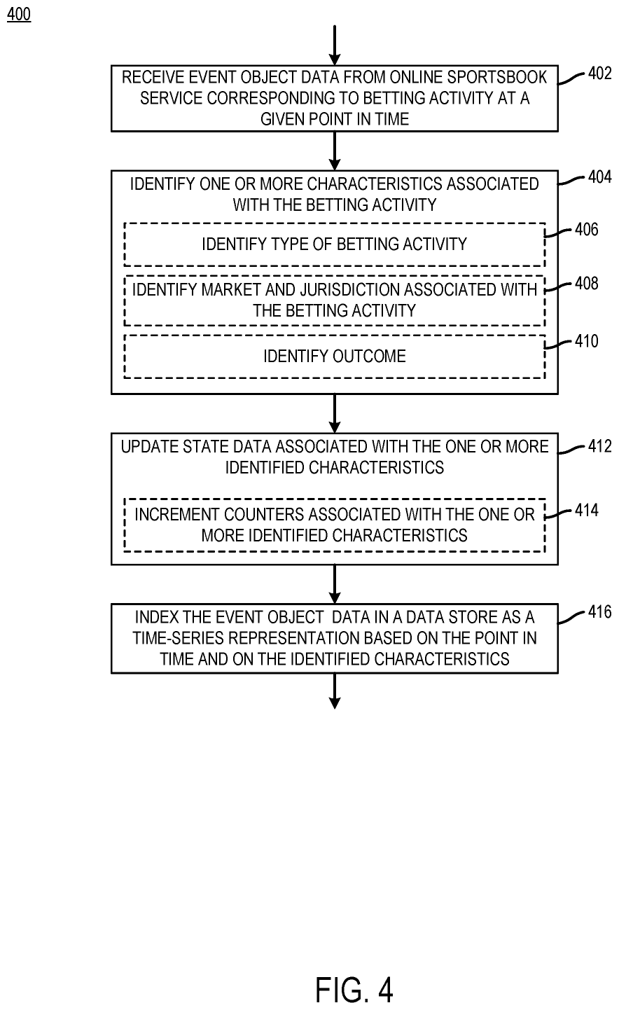

Referring now to FIG. 4, the server system 104, in operation, may execute a method 400 for tracking trending activity of an online sportsbook service (e.g., the online sportsbook service 302). As shown, the method 400 begins in block 402, in which the server system 104 receives event object data from the online sportsbook service corresponding to an activity taking place on the sportsbook platform, such as a bet placement. For example, assume that a user on the sportsbook platform places, via the app 110 executing on the client device 108, a moneyline bet on a basketball game between teams from two major markets set to occur several days after the moneyline bet is placed. The app 110 may package the bet placement as an event object including the details of the moneyline bet and transmit the event object to the server system 104.

In block 404, the server system 104 identifies, from the event object data, one or more characteristics associated with the betting activity. More particularly, the server system 104 may identify the parameters packaged with the event object data as well as metadata regarding the underlying event. For example, in block 406, the server system 104 identifies, from the event object data, a type of betting activity (e.g., whether the activity corresponds to a moneyline bet, spread bet, or over/under bet, and/or whether the activity corresponds to a single bet or a parlay bet). As another example, in block 408, the server system 104 identifies, from the event object data, a market (e.g., the sports league associated with the bet, the teams associated with the bet, etc.) and a jurisdiction (e.g., a geographic region in which the bet was placed) associated with the betting activity. As yet another example, in block 410, the server system 104 identifies a wagered outcome associated with the betting activity.

In block 412, the server system 104 updates state data associated with each of the one or more identified characteristics. In an embodiment, each characteristic may be associated with a corresponding counter, which, in block 414, the server system 104 may increment if observed in the event object. In block 416, the server system 104 indexes the event data. The database in which the event data is indexed may maintain a total count of bets, e.g., in an n-tuple-based data structure, or as a time-series representation of such tuples, which allows the server system 104 to perform time-based trending lookbacks. The granularity of the tuple is customizable. In practice, the tuple may be of a one minute granularity, though other lengths of time may be used.

In an embodiment, to reduce write contentions in such an approach, the server system 104 may use a cache to perform in-memory event object aggregation. Doing so avoids contention and large volumes of write operations within the database. In an embodiment, the platform 102 may accomplish this by implementing one or more data structures under a scalable and distributed framework (e.g., a grain structure provided by the Orleans framework of Microsoft Corp.). For example, one data structure may be used to receive all bets placed on a given event and maintain an in-memory count of bets placed by market type for a given amount of time (e.g., for each minute) as a persisted state. Another data structure may be used to maintain a cached local copy of event counts by event for a given sports league. The server system 104 may use the latter data structure for identifying which bets are trending based on in-memory aggregation (e.g., counting, sorting, and filtering operations).

By tracking bet placement event objects in such a manner as time-series data, the server system 104 is able to identify trending activity within the platform 102 based on changes in event characteristics within a given period of time. Continuing the previous example of the user moneyline bet on an upcoming basketball game between two major market teams, assume that there is an increased amount of bet placement activity within the online sportsbook service for the upcoming basketball game. In addition to a running tally of bets placed for the basketball game, the server system 104 is able to identify trends based on other characteristics associated with the bets, e.g., a steep increase in bets from a given geographic region over a certain period of time, a gradual decrease in bets favoring one of the associated teams compared to previous games involving that team, an increase in one type of bet (e.g., moneyline betting) compared with another type (e.g., over/under betting or player prop betting) within the platform as a whole over a given period of time, etc.

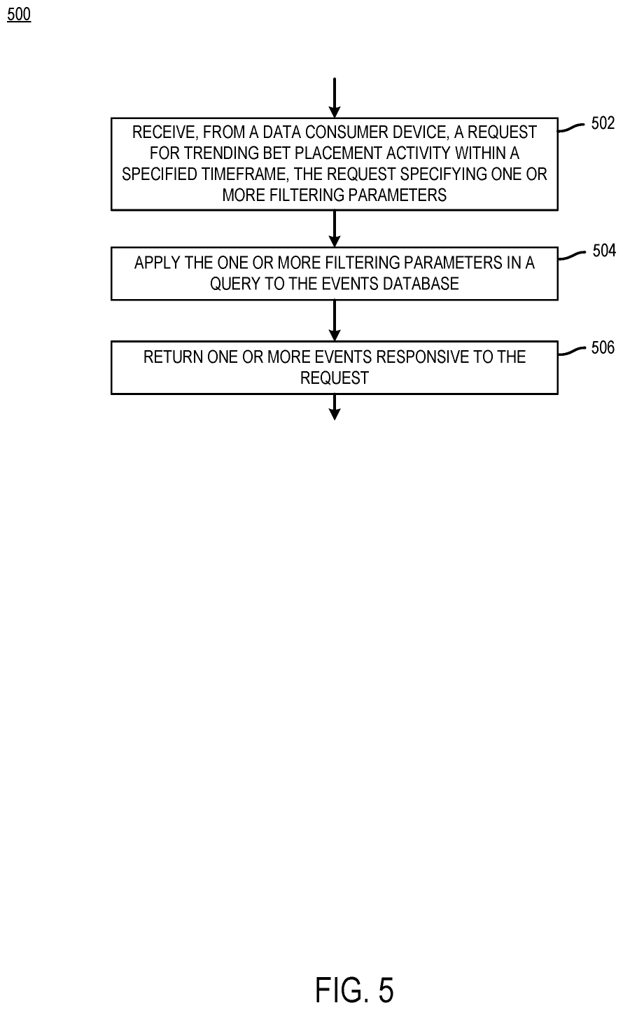

As stated, the platform 102 may allow users, such as third-party services 116, to access trending activity data associated therewith, such as by APIs exposed by the platform 102 providing functions to obtain such data. Referring now to FIG. 5, the server system 104, in operation, may perform a method 500 for processing requests to aggregate the indexed time-series data to identify trends within the data. As shown, the method 500 begins in block 502, in which the server system 104 receives a request for trending data within a specified timeframe from a data consumer device. For instance, the request may originate as an API call made by the consumer device to a given API endpoint on the platform 102. Example requests may be for trending bets, for trending markets, trending outcomes, betting splits (e.g., by league), and so on.

In addition, the request may further specify one or more filters as parameters, such a market type (e.g., a type of betting market), a sports league, bets on events having start times within a given range, betting activity within a given lookback period, events that start with a duration of time in a given range (on a rolling basis) based on preset timestamps, bettor activity within a given lookback duration (on a rolling basis) based on present timestamps, betting activity within a given jurisdiction, a number of events. The request may also specify query parameters for betting splits, such as whether to include odds data or limits to an amount of results being output. Other examples of filter parameters that may be used are event name (and/or event identifier), team name, where on the platform that the bets are taking place, and whether the bet activity corresponds to prematch or live bets. In block 504, the server system 104 applies the one or more specified filters in a query to the events database. The server system 104 then queries the database to obtain an aggregate of the data responsive to the request.

In block 506, the server system 104 returns the output to the requesting entity. In an embodiment, the output may be expressed as an ordered list of event objects, e.g., ordered by aggregate bet count (e.g., for requests pertaining to trending bets), ordered by start date (e.g., for requests pertaining to betting splits) or aggregate bet handle for a given bet. Each event object returned by the server system 104 may include, for example, an identifier associated with the event, an event name, a sports league associated with the event, a start date of the event, betting market information (e.g., market type, outcome, odds, etc.). In some embodiments, the server system 104 may also generate and provide other information based insights performed on the returned event object data, such as information relating to each of the characteristics or parameters discussed above, a deeplink to add a bet to a betslip for a given trending activity, and current odds for a given trending activity.

Data consumers may use the returned output in a variety of use cases. For example, marketing channels or social media networks may generate leaderboards using the data that can be published online (e.g., on a website, on a sports-oriented television program, etc.). For instance, entities may program widgets to highlight popular bets on their content. As another example, the sportsbook service may promote bets identified as trending to drive further user engagement across the platform 102. For instance, the sportsbook service may execute logic to promote trending bets to appear on a user's feed in a higher frequency, or add a visual indicator within the user interface indicating that a given bet is trending in some manner. As yet another example, dynamic content blocks including trending bet activity for a given time period may be created to supplement email messages, e.g., to highlight trending betting markets and bet splits.

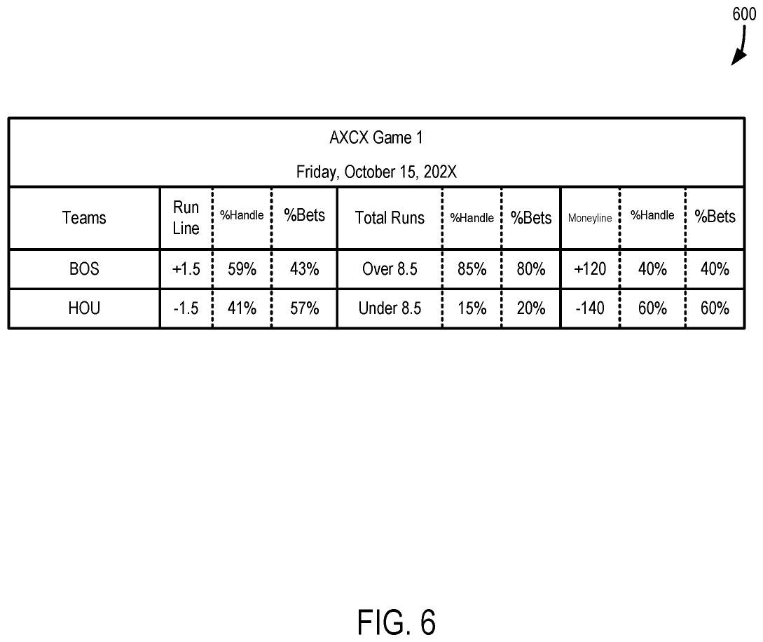

FIG. 6 illustrates an example event object output 600 returned to a data consumer device (e.g., a client device 108 or device of a third-party service 116) in response to an API query call. In this example, the system 104 provides a table view of a prematch sports event (labeled “AXCX Game 1”) taking place on a given date (labeled “Friday, October 15, 202X”) between BOS and HOU teams. For each team, the output 600 provides a percentage breakdown of three types of bets: moneyline, spread, and over/under bets, each by bet count and by handle.

For the purposes of promoting an understanding of the principles of the present disclosure, reference is made herein to preferred embodiments and specific language is used to describe the same. It will nevertheless be understood that no limitation of the scope of the disclosure is thereby intended and various alterations and/or modifications are within the scope of the present disclosure.

Articles “a” and “an” are used herein to refer to one or to more than one (i.e. at least one) of the grammatical object of the article. By way of example, “an element” means at least one element and can include more than one element.

“About” is used to provide flexibility to a numerical range endpoint by providing that a given value may be “slightly above” or “slightly below” the endpoint without affecting the desired result.

The use herein of the terms “including,” “comprising,” or “having,” and variations thereof, is meant to encompass the elements listed thereafter and equivalents thereof as well as additional elements. As used herein, “and/or” refers to and encompasses any and all possible combinations of one or more of the associated listed items, as well as the lack of combinations where interpreted in the alternative (“or”).

Moreover, the present disclosure also contemplates that in some embodiments, any feature or combination of features set forth herein can be excluded or omitted. To illustrate, if the specification states that a complex comprises components A, B and C, it is specifically intended that any of A, B or C, or a combination thereof, can be omitted and disclaimed singularly or in any combination.

Unless otherwise defined, all technical terms used herein have the same meaning as commonly understood by one of ordinary skill in the art to which this disclosure belongs.

Another aspect of the present disclosure is a system. The system can be implemented in hardware, software, firmware, or combinations of hardware, software and/or firmware. In some examples, the system and methods described in this specification may be implemented using a non-transitory computer readable medium storing computer executable instructions that when executed by one or more processors of a computer cause the computer to perform operations.

Another aspect of the present disclosure provides all that is described and illustrated herein.

The present disclosure is well adapted to carry out the objects and obtain the ends and advantages mentioned, as well as those inherent therein. The embodiments of the present disclosure described herein are presently representative of preferred embodiments, are examples, and are not intended as limitations on the scope of the present disclosure. Changes therein and other uses are encompassed within the spirit of the present disclosure as defined by the scope of the claims.

No admission is made that any reference, including any non-patent or patent document cited in this specification, constitutes prior art. In particular, it will be understood that, unless otherwise stated, reference to any document herein does not constitute an admission that any of these documents forms part of the common general knowledge in the art in the United States or in any other country. Any discussion of the references states what their authors assert, and the applicant reserves the right to challenge the accuracy and pertinence of any of the documents cited herein. All references cited herein are fully incorporated by reference, unless explicitly indicated otherwise. The present disclosure shall control in the event there are any disparities between any definitions and/or description found in the cited references.

1. A system comprising:
one or more processors; and
a memory storing a plurality of instructions, which, when executed on the one or more processors, causes the system to:
receive data corresponding to an event occurring at a point in time within a software-based platform,
identify a plurality of characteristics associated with the data corresponding to the event,
update state data associated with each identified characteristic in a data store maintaining time-series data that represents a plurality of events that have occurred within the software-based platform,
index the data corresponding to the event in the data store, wherein the data is indexed as a time-series representation based on the point in time associated with the event and on the identified plurality of characteristics, and
provide, to one or more data consumer devices, access to the time-series data via a plurality of application programming interface (API) functions.

2. The system of claim 1, wherein to provide, to the one or more data consumer devices, the access to the time-series data via the plurality of API functions comprises to:
receive, from one of the data consumer devices, a query for a subset of the time-series data, the query comprising one or more filtering parameters, wherein the subset indicates a trend in one of the identified characteristics based on the state data;
apply the one or more filtering parameters to the time-series data to obtain the subset; and
output the subset to the one of the data consumer devices.

3. The system of claim 1, wherein to update the state data associated with each identified characteristic comprises to increment a counter for each identified characteristic in the data store.

4. The system of claim 1, wherein the software-based platform comprises an online sportsbook platform and wherein the data corresponding to an event occurring at a point in time corresponds to data corresponding to a bet placed by a client device on the online sportsbook platform.

5. The system of claim 4, wherein to identify the plurality of characteristics associated with the data corresponding to the event comprises to identify one of at least a type of betting activity, a market and jurisdiction, or a betting outcome associated with the data.

6. The system of claim 5, wherein the plurality of instructions further causes the system to maintain, via a cache, an in-memory count of bets placed by market type for a given amount of time as a persisted state.

7. The system of claim 5, wherein the plurality of instructions further causes the system to:
maintain, via a cache, a copy of a count of bets by event; and
identify, from the time-series data, which of the bets are trending based on in-memory aggregation operations.

8. A computer-readable storage medium storing instructions, which, when executed on one or more processors, causes a system to:
receive data corresponding to an event occurring at a point in time within a software-based platform;
identify a plurality of characteristics associated with the data corresponding to the event;
update state data associated with each identified characteristic in a data store maintaining time-series data that represents a plurality of events that have occurred within the software-based platform;
index the data corresponding to the event in the data store, wherein the data is indexed as a time-series representation based on the point in time associated with the event and on the identified plurality of characteristics; and
provide, to one or more data consumer devices, access to the time-series data via a plurality of application programming interface (API) functions.

9. The computer-readable storage medium of claim 8, wherein to provide, to the one or more data consumer devices, the access to the time-series data via the plurality of API functions comprises to:
receive, from one of the data consumer devices, a query for a subset of the time-series data, the query comprising one or more filtering parameters, wherein the subset indicates a trend in one of the identified characteristics based on the state data;
apply the one or more filtering parameters to the time-series data to obtain the subset; and
output the subset to the one of the data consumer devices.

10. The computer-readable storage medium of claim 8, wherein to update the state data associated with each identified characteristic comprises to increment a counter for each identified characteristic in the data store.

11. The computer-readable storage medium of claim 8, wherein the software-based platform comprises an online sportsbook platform and wherein the data corresponding to an event occurring at a point in time corresponds to data corresponding to a bet placed by a client device on the online sportsbook platform.

12. The computer-readable storage medium of claim 11, wherein to identify the plurality of characteristics associated with the data corresponding to the event comprises to identify one of at least a type of betting activity, a market and jurisdiction, or a betting outcome associated with the data.

13. The computer-readable storage medium of claim 12, wherein the plurality of instructions further causes the system to maintain, via a cache, an in-memory count of bets placed by market type for a given amount of time as a persisted state.

14. The computer-readable storage medium of claim 12, wherein the plurality of instructions further causes the system to:
maintain, via a cache, a copy of a count of bets by event; and
identify, from the time-series data, which of the bets are trending based on in-memory aggregation operations.

15. A method comprising:
receiving, by a computing system, data corresponding to an event occurring at a point in time within a software-based platform;
identifying, by the computing system, a plurality of characteristics associated with the data corresponding to the event;
updating, by the computing system, state data associated with each identified characteristic in a data store maintaining time-series data that represents a plurality of events that have occurred within the software-based platform;
indexing, by the computing system, the data corresponding to the event in the data store, wherein the data is indexed as a time-series representation based on the point in time associated with the event and on the identified plurality of characteristics; and
providing, by the computing system and to one or more data consumer devices, access to the time-series data via a plurality of application programming interface (API) functions.

16. The method of claim 15, wherein to provide, to the one or more data consumer devices, the access to the time-series data via the plurality of API functions comprises to:
receiving, by the computing system and from one of the data consumer devices, a query for a subset of the time-series data, the query comprising one or more filtering parameters, wherein the subset indicates a trend in one of the identified characteristics based on the state data;
applying, by the computing system, the one or more filtering parameters to the time-series data to obtain the subset; and
outputting, by the computing system, the subset to the one of the data consumer devices.

17. The method of claim 15, wherein updating the state data associated with each identified characteristic comprises incrementing, by the computing system, a counter for each identified characteristic in the data store.

18. The method of claim 15, wherein the software-based platform comprises an online sportsbook platform, wherein the data corresponding to an event occurring at a point in time corresponds to data corresponding to a bet placed by a client device on the online sportsbook platform, and wherein identifying the plurality of characteristics associated with the data corresponding to the event comprises identifying, by the computing system, one of at least a type of betting activity, a market and jurisdiction, or a betting outcome associated with the data.

19. The method of claim 18, further comprising maintaining, by the computing system and via a cache, an in-memory count of bets placed by market type for a given amount of time as a persisted state.

20. The method of claim 18, further comprising:
maintaining, by the computing system and via a cache, a copy of a count of bets by event; and
identifying, by the computing system and from the time-series data, which of the bets are trending based on in-memory aggregation operations.
